(19) United States
(12) Patent Application Publication
(10) Pub. No.: US 2008/0061233 A1
(43) Pub. Date: Mar. 13, 2008

(54) Semiconductor Inspection Method And System Therefor

(76) Inventor: Takashi Ogawa, Chiba-shi (JP)

Correspondence Address: Bruce L. Adams;Adams & Wilks, 17 Battery Place-Suite 1231, New York, NY, 10004, US

(21) Appl. No.: 10/590,127

(22) PCT Filed: Feb. 18, 2005
(86) PCT No.: PCT/JP05/02537

§ 371 Date: Oct. 13, 2006

(30) Foreign Application Priority Data
Feb. 25, 2004 (JP) 2004-050296

(51) Int. Cl. G01N 23/225

(52) U.S. Cl. 250/307

(57) ABSTRACT

To provide an inspection method that makes it possible to inspect continuity or the like of a circuit element in a semiconductor device from observation with a scanning charged particle microscope such as an electron microscope without troublesome work like random access operation of a probe, and providing a system that realizes the inspection method.

A method for inspecting an electronic circuit of the invention uses a composite apparatus including an electron gun 2, an ion beam gun 1, and a secondary charged particle detector 4 to observe on a micro-scale contrast change on a sample surface in the case in which the surface of a sample semiconductor device is irradiated with an electron beam or a positively charged ion beam to charge the sample surface highly, and in the case in which a desired pattern in an area in the highly charged state is irradiated with a charged ion beam or an electron beam of opposite charge.

### TECHNICAL FIELD

The present invention relates to a semiconductor inspection method and a focused ion beam (FIB) apparatus including a scanning electron microscope (SEM) suitable for the inspection of a semiconductor.

### BACKGROUND ART

While a sample is observed by an SEM apparatus that includes a conductive probe in a system, when the probe touches a local area of a sample, a phenomenon in which that area shown on a display brightens or, to the contrary, darkens is observed. This phenomenon is called a potential contrast. On the left in FIG. 8, the case is shown where a sample surface on which a wiring R is exposed is observed by an SEM, the wiring R portion is displayed brightly in the SEM image. Also, in this phenomenon, when a conductive probe P comes into contact with a wiring B portion which has been displayed brightly, the contacted portion of the wiring R darkens as shown on the right in FIG. 8. This means that a sample surface is irradiated on in the SEM observation with a negatively charged electrons and, in the state in which the wiring B portion is charged by the electrons, the conductive probe P comes into contact with the wiring B portion and discharges the charge, whereby the potential of that portion changes. When an electron beam is used for scanning in, for example, a raster order on a sample surface, since a secondary electron is emitted due to the properties of the irradiated portion, the image of the SEM is obtained by detecting this secondary electron and associating the secondary electron with the irradiated position to display the sample image two-dimensionally. In the case where a certain area of the sample is positively charged as shown in the upper half of FIG. 9, since a secondary electron emitted following irradiation by an electron beam has a negative charge, the secondary electron is attracted by this area and comes into a state in which it is difficult for the secondary electron to reach a secondary electron detector (SED) and is not detected easily. Therefore, an image in that portion darkens. On the other hand, in the case where a certain area of a sample is negatively charged as shown in the lower half of FIG. 9, a repulsion caused by the charging of this area repels secondary electrons emitted after irradiation by an electron beam, and the electron beam is easily pushed out toward and detected by the secondary electron detector. Therefore, the image in that portion brightens. A non-patent reference 1 discloses a technique for inspecting continuity of wiring and presence or absence of a defect according to a change in a voltage contrast (VC), which is caused in the wiring by bringing a conductive probe into contact with a semiconductor device, utilizing this phenomenon.

In this inspection method, an operator has to carry a probe to an area such as a wiring portion to be an inspection object while observing a sample surface with an SEM. The random access of the probe is troublesome work for the operator and takes time.

[Patent reference 1]

JP-A-2-123749 “Section Machining Observation Apparatus” page 2, FIG. 3.

[Non-patent reference 1]

K. Ura and H. Fujioka, “Electron Beam Testing”, Advances in Electronics and Electron Physics Vol. 73 p. 247 FIG. 8

### DISCLOSURE OF THE INVENTION

### Problems that the Invention is to Solve

The problem that the invention is to solve requires proposal of an inspection method that makes it possible to inspect the continuity or the like of a circuit element in a semiconductor device from observation with a scanning charged particle microgun such as an electron microgun without troublesome work like random access operation of a probe, and providing a system that realizes the inspection method.

### Means for Solving the Problems

An inspection method of the invention is characterized by microscopically observing and analyzing the states when a sample surface is irradiated with an electron beam or a positively charged ion beam to charge the sample surface, and when an area in a highly charged state is irradiated with an oppositely charged ion beam or an electron beam, to determine the change in the charge state.

An inspection system of the invention is a composite apparatus that has an electron gun, an ion beam gun, and a secondary charged particle detector, including means for irradiating a sample surface with charged particles from one of the guns, observing a sample surface on a micro-scale, and irradiating with charged particles of a charge opposite to the charged particles from the initial gun.

### Advantages of the Invention

The semiconductor inspection method of the invention uses a microscope to observe and analyze the change between the states in which a sample surface is irradiated with an electron beam or an ion beam with a positive charge to charge the sample surface, and in which an area in a highly charged state is irradiated with an ion beam or an electron beam of charge opposite to the initial beam. Thus, since only the beam spot position in a specific area has to be determined and the work of carrying a probe is not necessary, the burden on the operator is light and work time can be reduced.

In addition, in the semiconductor inspection method of the invention a sample is irradiated by an electron beam on to negatively charge the sample and the sample is observed with an SEM, the sample is spot-irradiated with a positively charged ion beam and reversal of contrast is observed with an SEM, wherein the acceleration voltage of the ion beam for spot-irradiation is set at a low acceleration of 10 kV or less. Thus, it is possible to prevent harmful contamination of a sample surface due to sputter etching and residual ions.

Further, in the semiconductor inspection method of the invention, the ion beam for spot-irradiation is an ion beam in intermittent pulses each with a predetermined amount of charge, whereby it is possible to digitally measure the amount of charge applied according to the number of pulses.

Moreover, it is possible to realize an inspection for analyzing various states by applying the inspection method of the invention to standard samples and determining differences.

The inspection system of the invention is a composite apparatus that has an electron gun, an ion beam gun, and a secondary charged particle detector, including means for irradiating a sample surface with charged particles from one of the guns, observing the sample surface on a micro-scale, and irradiating with charged particles of charge opposite to the radiation from the other gun. Thus, the semiconductor inspection system does not require troublesome work of moving a probe to a specific position with manipulator operation and carry out inspection of a sample with merely the operation of irradiation position control of a charge particle beam. Moreover, the semiconductor inspection system further includes a unit that outputs position information of the area covered by a microscopic image and a unit that irradiates the position which is designated based on the position information with the charged particle beam. Consequently, the semiconductor inspection system can move the charged particle beam to a specific position at high speed and accurately.

### BRIEF DESCRIPTION OF THE DRAWINGS

FIG. 1 is a diagram showing a basic structure of a system that carries out an inspection method of the invention.

FIG. 2 is a diagram explaining a phenomenon of the invention utilizing electron charging.

FIG. 3 is a diagram explaining a phenomenon of the invention utilizing positive ion charging.

FIG. 4 is a diagram explaining operation of the invention utilizing injection of an opposite charge in pulses.

FIG. 5 is a diagram explaining an operation of the invention in which an ion charge is injected at a low acceleration voltage.

FIG. 6 is a diagram explaining wiring continuity inspection that is performed according to the invention.

FIG. 7 is a diagram explaining a wiring failure inspection that is performed according to the invention.

FIG. 8 is a diagram explaining a conventional technique that is a basis of the present invention.

FIG. 9 is a diagram explaining the cause of a phenomenon utilized by the invention.

### DESCRIPTION OF REFERENCE NUMERALS AND SIGNS

1 FIB gun
2 SEM gun
3 Vacuum chamber
4 Secondary electron detector
5 Computer
6 Display
7 Input unit
8 FIB power supply
9 SEM power supply
P Probe
R Wiring

### BEST MODE FOR CARRYING OUT THE INVENTION

The invention performs an inspection of a semiconductor using a composite apparatus including both a scanning electron microscope (SEM) and a focused ion beam (FIB) apparatus. Conventionally, a composite apparatus of a so-called double gun including an electron gun and an ion beam gun has been used in a system where observation with the SEM of samples machined by the FIB, a system that can perform prompt and accurate machining (see the patent reference 1). Although the present invention uses a similar SEM/FIB complex apparatus, it is based on a completely new technical idea for inspecting a semiconductor utilizing the fact that, in the case in which a positive ion is adopted as an ion source, charges of an electron and the ion are opposite.

First of all, the flow of the inspection method of the invention starts with the operator giving a charge to a sample. In this charging, an electron beam is used in some cases and an ion beam is used in other cases. In the case in which the electron beam is used, the operator sets a beam current of the SEM to be large (the scale of n A) and irradiates the sample with the electron beam to negatively charge the sample (step 1).

Next, the operator observes a sample surface using the SEM (step 2). A pattern corresponding to the structure of the sample is observed from the SEM image at this point, and at the same time the contrast of the pattern changes according to a charge applied by the SEM. The operator can perform this observation while irradiating the sample with the electron beam for charging. In that case, it can be observed that the contrast gradually becomes stronger as the sample is charged more highly. The operator can also analyze each structural element by comparing change at this point with the change in a standard sample.

When the contrast change due to the charging is determined, the operator sets a beam of ions to irradiate an inspection target point on the sample which the operator desires, to inject a positive charge (step 3).

The operator observes the state of the sample surface with the SEM after emitting ions in step 3 (step 4). Here, if an area showing the same contrast change as at the target point is observed, the operator can judge that the area and the target point are connected with each other and can estimate a capacitor capacitance value and a resistance value of the target point from the degree of contrast change. In other words, since a change in potential due to the injection of a positive charge in the ion irradiation area appears in an SEM image as a voltage contrast, it is possible to perform electronic circuit analysis, such as verification of continuity of wiring and presence or absence of a defect (continuity of wiring, contact failure, and transistor failure), for the area from the change.

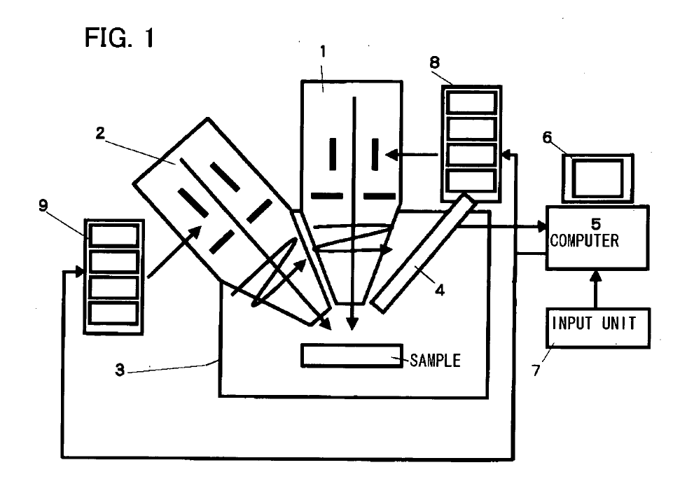

FIG. 1 shows a basic structure of a system for executing the inspection method of the invention. Reference numeral 1 denotes an FIB gun; 2, an SEM gun; 3, a vacuum chamber; 4, a secondary electron detector; 5, a computer for controlling this system; 6, a display; 7, an input unit to the computer 5; 8, an FIB power supply; and 9, an SEM power supply.

The respective steps of the inspection flow will be explained on the basis of this diagram.

### Step 1

The operator inputs his selection whether an electron or an ion shall be used for charging, and his setting of the magnitude of the beam current, via an input unit 7 such as a keyboard. In response to the input, the computer 5 sends setting information to the FIB power supply 8 or the SEM power supply 9 of the designated FIB gun 1 or SEM gun 2 to irradiate a sample with charged particles to both observe and charge the sample. A case in which electrons from the SEM gun 2 are used for charging will be hereinafter described. In the case where a large current is used for observation of the sample, at a stage when the charging progresses sufficiently and a contrast change is made clear, a current value of an electron beam is reduced to switch an observation mode to an observation mode that takes into account only an observation function.

### Step 2

When the SEM gun 2 executes electron beam scanning for microscopic operation in response to a scanning instruction from the computer 5, a secondary electrons are emitted from the point the electron beam 1 irradiated, the secondary electron detector 4 detects the secondary electron, and the secondary electron detector 4 stores the detected value of the secondary electrons in the computer 5 together with position data. When data of a scanning area is stored and accumulated, the computer 5 outputs the data to the display 6 as image information, and the display 6 displays the sample image at that point.

### Step 3

When the operator determines a target point which the operator desires to inspect from the sample image and designates the position of that target point on the display using an input unit 7 such as a mouse, the computer 5 sends position information of the target point to the FIB gun that has the charge for neutralizing the initial charging. The FIB gun which has received this position signal adjusts a deflector so that the beam is set at the target point and emits an ion beam at a designated acceleration voltage to inject an ion.

### Step 4

The electron gun is operated under the micro-scale control of the computer 5, and the operator observes the state of the sample surface when the ion irradiation in step 3 is performed.

### FIRST EMBODIMENT

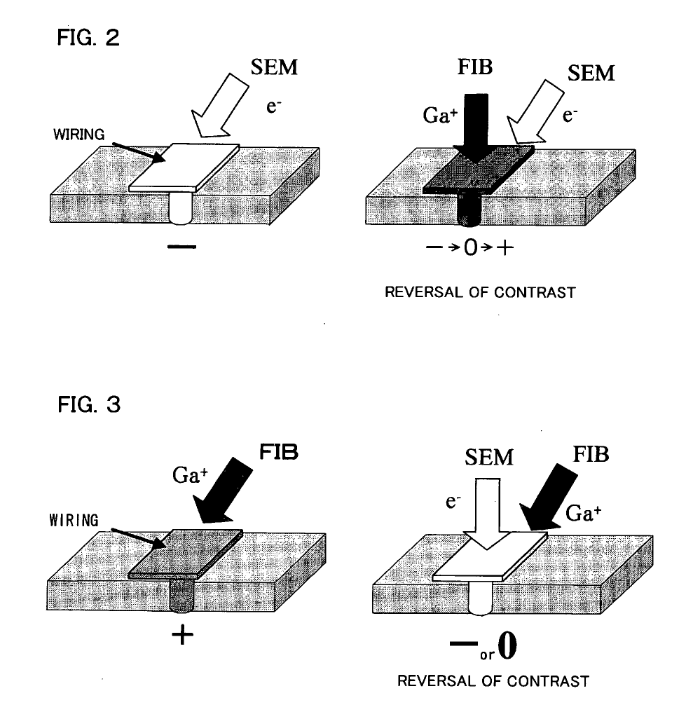

FIG. 2 shows an embodiment of the semiconductor inspection method of the invention. When an electron beam of an SEM to scan a sample surface to charge the sample surface with a negative charge and to observe the sample surface on a micro-scale is set to be large, the wiring portion is bright compared with the substrate portion around the wiring portion. The left side in FIG. 2 shows this state. Then, an operator places the cursor on this wiring area of the microscopic image and clicks the input unit 7. Then, the computer 5 reads position information of the wiring area and sends the position information to the FIB gun 1. The FIB gun 1, which has received the position information, controls the deflection mechanism so that the beam irradiation position is set to be the wiring area, and irradiates the wiring area with positive ions such as Ga⁺ in the beam current. While the observation by the SEM is performed, it can be observed that the wiring portion gradually darkens, finally becoming darker than the substrate portion around the wiring portion so that the contrast is reversed.

### SECOND EMBODIMENT

FIG. 3 shows an embodiment in which an FIB is used for charging and observation and the charging is neutralized by an electron beam which charges the sample surface with the opposite charge. The sample surface is irradiated by a positive ion such as Ga⁺ and thus is positively charged. Further, the potential is increased in the wiring portion, and secondary electrons emitted after FIB irradiation are attracted to the sample and it is difficult for them to reach the secondary electron detector 4. Therefore, as shown on the left side in FIG. 3, the wiring portion is darker compared with the substrate portion around the wiring portion. Thus, when an operator places a cursor on this wiring area on a microscopic image and clicks the input unit 7, the computer 5 reads position information of the wiring area and sends the position information to the SEM gun 2. The SEM gun 2 which receives the position information controls the deflection mechanism so that the beam irradiation position is set at the writing area and emits an electron beam with a set beam current. While the observation by the scanning ion microscope (SIM) is performed, it can be observed that the wiring portion gradually brightens and finally becomes brighter than the substrate portion around the wiring portion so that the contrast is reversed.

### THIRD EMBODIMENT

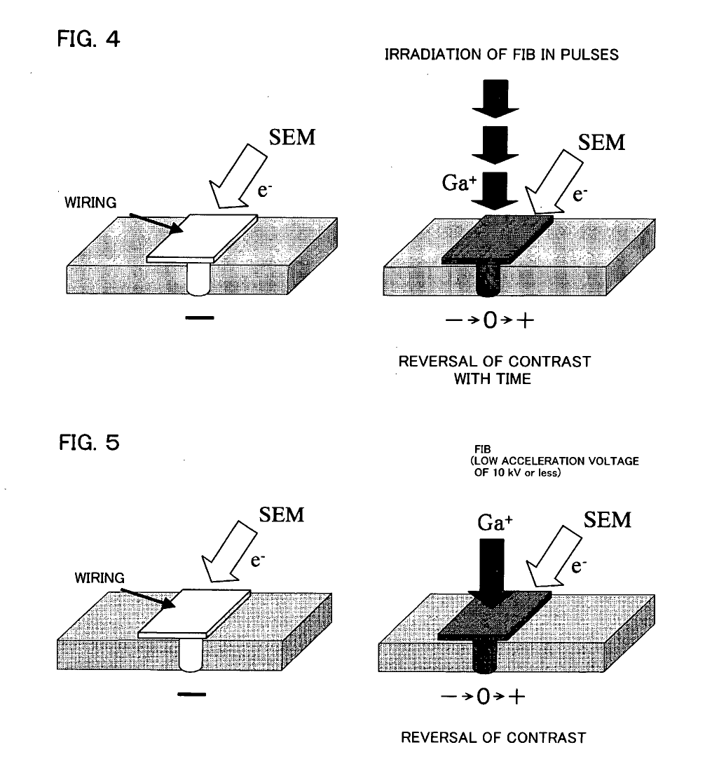

FIG. 4 shows an example in which a positively charged ion beam is used for charge neutralization and an FIB thereof is emitted in intermittent pulses. Basically, the operation in this example is the same as that described in paragraph [0008]. However, as shown on the left side in FIG. 4, in a state in which the wiring portion is brighter than the substrate portion around the wiring portion, an operator sets a cursor on this wiring area and clicks the input unit 7. As in the example described above, the computer 5 reads position information of the wiring area and sends the position information to the FIB gun 1, and the FIB gun 1, which has received the position information, controls the deflection mechanism so that the beam irradiation position is set on the wiring area. However, in this case, a positive ion such as Ga⁺ is intermittently irradiated in a pulse shape rather than being continuously irradiated with a set beam current. The positive ion is pulse-irradiated by controlling a blanking electrode in the FIB gun 1. While the observation by the SEM is performed, it can be observed that, as the number of pulses increases, the wiring portion gradually darkens and finally becomes darker than the substrate portion around the wiring portion so that the contrast is reversed. It is possible to associate the number of pulses and the state of change, enabling analysis of digital values. In addition, depending on settings for strength of the electron beam and the ion beam and the pulse on/off time of the ion beam, it is possible to observe a phenomenon in which a contrast is reversed during a period of pulse irradiation of the ion beam, the contrast is reversed in the opposite manner by an electron charge during a period of interruption, and these reversals are repeated with every pulse irradiation. In the second embodiment, the same advantage is obtained by emitting an electron beam in pulses.

### FOURTH EMBODIMENT

In a form shown in FIG. 5, an FIB used in neutralizing charging is emitted at a low acceleration voltage of 10 kV or less. Ion irradiation at an increased acceleration voltage causes a phenomenon in which a sample surface is etched or an ion is implanted and remains in the sample. In this embodiment, in order to reduce such damage that the sample suffers due to FIB irradiation, an acceleration voltage of the FIB is controlled to be low. In the second embodiment, it is possible to reduce the damage by an FIB used for charging by keeping the acceleration voltage at 10 kV or less.

### FIFTH EMBODIMENT

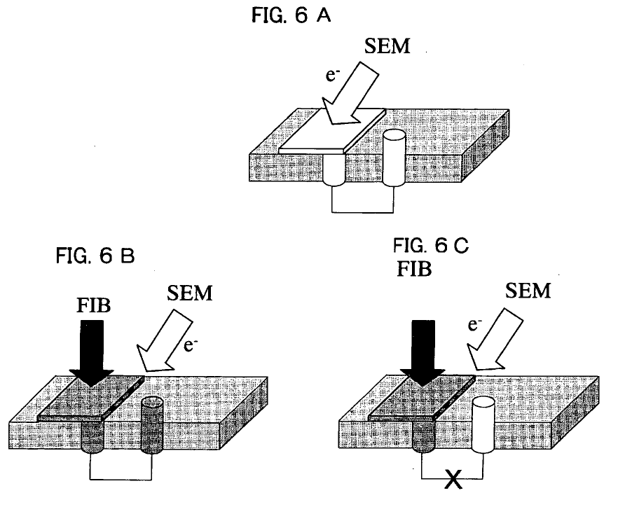

In FIG. 6 is shown an embodiment where a disconnection inspection can be performed easily with the inspection method of the invention. Shown here is an example in which it is confirmed whether a highly charged wiring portion and an element are connected with each other. As shown in A in FIG. 6, in the case that there is an area with a highly charged wiring portion and an element in a scanning area on the sample surface, to confirm whether the wiring and the element are connected with each other, the area in question is irradiated with a neutralizing beam and it is observed whether the element and the wiring area show the same contrast change. The area in question is irradiated with the FIB as shown in B in the figure and, if contrast changes in the element in the same manner as the wiring, it is judged that the wiring and the element are connected with each other. If there is no change of contrast in the element, the wiring area and the element area are disconnected.

### SIXTH EMBODIMENT

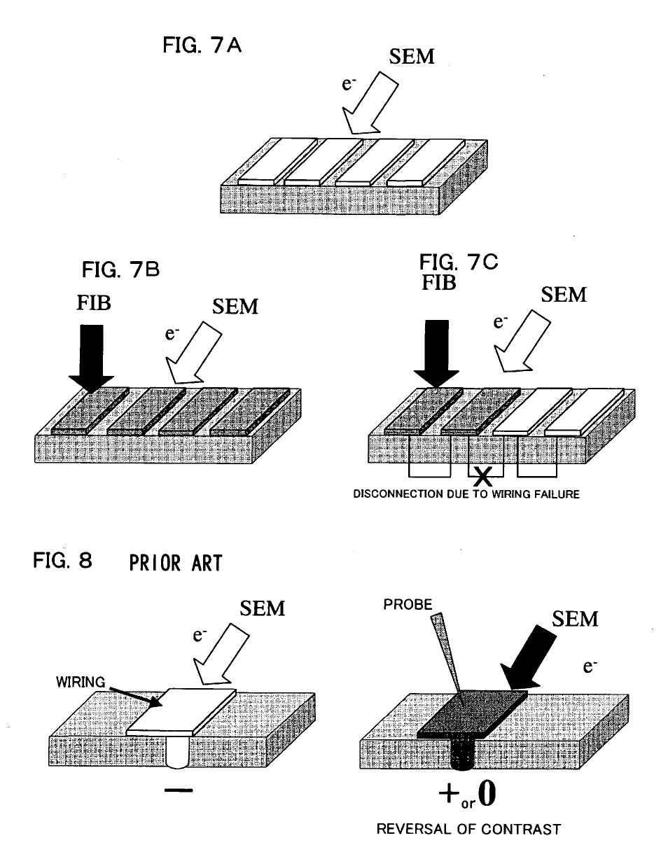

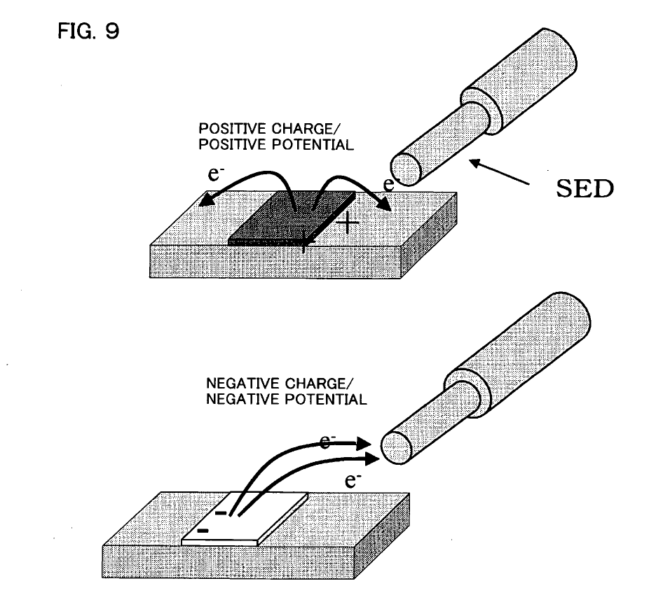

In the embodiment shown in FIG. 7, it is confirmed with which element a highly charged wiring portion is connected. As shown in A in FIG. 7, assuming that there are plural highly charged points in a scanning area on a sample surface, to confirm which of the points conducts with the wiring in question, a neutralizing beam is irradiated on the wiring to find points showing the same contrast change as the wiring. If all the points show the same contrast change as the wiring in question as shown in B in FIG. 7, all the points are connected with the wiring. Even if these points are connected in series, if the points from an area in the middle onward do not show a change in contrast as shown in C in the figure, those points and the wiring are not connected. In addition, if there is an area in which contrast changes with a time delay with respect to change in the wiring in question, it can be assumed that the area and the wiring area are connected at a certain impedance. Moreover, it is also possible to compare time-wise contrast change in a sample with time series of changes in a standard sample to thereby perform various quality diagnoses on the sample.

### INDUSTRIAL APPLICABILITY

As described above, the semiconductor inspection method of the invention is performed using an SEM/FIB composite apparatus. Thus, the system for carrying out the semiconductor inspection method of the invention does not have to be a system dedicated for inspection. The system can execute work ranging from machining of a sample to the inspection method presented in the invention as a continuous work process in the same chamber, and this system can be realized simply by improving the conventional SEM/FIB complex apparatus that performs section cutout machining for a sample.

In addition, if a defective portion can be identified by executing an inspection of a semiconductor element according to this invention using the SEM/FIB composite apparatus, it is also possible to execute correction machining in a continuous process in the same chamber using the etching function and CVD function of an FIB.

1. A semiconductor inspection method, characterized by microscopically observing and analyzing both the state of a sample surface which is irradiated by an electro beam or a positively charged ion beam to charge the sample surface, and the change in the state when an area in a highly charged state is irradiated with an oppositely charged ion beam or an electron beam.

2. A semiconductor inspection method according to claim 1, wherein a sample is irradiated with an electronic beam to negatively charge the sample, the sample is observed by SEM, the sample is spot-irradiated with a positively charged ion beam, and reversal of a contrast is observed with an SEM.

3. A semiconductor inspection method according to claim 1, wherein a sample is irradiated with a positively charged ion beam to positively charge the sample, the sample is observed by an FIB, the sample is spot-irradiated by a negatively charged electron beam, and reversal of contrast is observed with an FIB.

4.-6. (canceled)

7. A semiconductor inspection system comprising a composite apparatus with a double function charged particle detector including an electron gun and an ion beam gun, wherein there are means for emitting charged particles from one of the guns to the surface of a sample; for microscopic observation of the sample surface; and for irradiation of a specific area with particles charged oppositely to the charged particles emitted from the other gun.

8. A semiconductor inspection system according to claim 7, comprising: a means for obtaining position information of a specified area by a microscope; and a means for irradiating the position which is designated on the basis of the position information, with a specified particle beam.

9. A semiconductor inspection method comprising: a first step of irradiating a predetermined area of a sample surface of a semiconductor device on which a wiring pattern is formed with a first charged particle beam to charge the predetermined area; and a second step of irradiating a second charged particle beam charged oppositely to the first charged particles, in a desired pattern in the predetermined charged area, characterized in that the change in the contrast on the sample surface after the second step from the time of the first step is observed by microscope using the first charged particle beam.
